(19) United States
(12) Patent Application Publication
(10) Pub. No.: US 2012/0180981 A1
(43) Pub. Date: Jul. 19, 2012

(54) Distributed Energy System Thermal Management System and Method

(75) Inventors: Thomas J. Dyer, Orlando, FL (US); William Yadusky, Milwaukee, WI (US); David Porter, East Troy, WI (US); Matthew K. Murphy, Orlando, FL (US); Ali Nourai, Columbus, OH (US)

(73) Assignee: S&C ELECTRIC COMPANY, Chicago, IL (US)

(21) Appl. No.: 13/155,050

(22) Filed: Jun. 7, 2011

Related U.S. Application Data
(60) Provisional application No. 61/352,496, filed on Jun. 8, 2010.

(51) Int. Cl. F24J 3/08

(52) U.S. Cl. 165/45

(57) ABSTRACT

A distributed energy storage or community energy storage unit incorporates a geothermal temperature regulation system. The system includes a sealed, chemically inert storage energy container or “pack” disposed within an underground chamber. The underground chamber is defined by a support structure or box pad 14 that includes side walls and a top or pad. Mechanical and electrical interfaces both to the utility connections and to the CES converter unit are also included.

### CROSS REFERENCE TO RELATED APPLICATIONS

This patent claims benefit to U.S. Provisional Patent Application Ser. No. 61/352,496 filed Jun. 8, 2010, the disclosure of which is hereby expressly incorporated herein by references for all permitted purposes.

### TECHNICAL FIELD

This patent relates to distributed energy systems incorporating distributed energy storage units and thermal management of the distributed energy storage units.

### BACKGROUND

Energy storage capacity on the electrical grid is desirable for many reasons. The stored energy of so-called distributed energy storage (DES) systems or community energy storage (CES) systems is combined with power electronics for active conversion from direct current (DC) to alternating current (AC) and coupling to the utility. The resulting AC power can be used in many ways, including voltage support, power factor correction, peak load shaving, islanding and VAR support.

One challenge to DES or CES systems is maintaining the operating environment of the storage unit, and in particular the operating temperatures for the energy storage element, such as batteries. Some factors that complicate thermal management are:

1. Widely varying natural external ambient weather conditions;

2. Widely varying power loses (heat generation) within the power converter and battery enclosure, depending on the mode of operation and electrical operating conditions;

3. The relative proximity of such heat-generating sources;

4. Constraints on the physical dimensions of the enclosures; and

5. Reliability and serviceability targets that restrict the use of active cooling devices such as fans and pumps.

A significant cost factor in CES units is the energy storage device, which may consist of any one of a variety of battery technologies, or a combination of battery technologies, such as: lead-acid; any of the various lithium-ion (Li-ion) chemistries, such as lithium metal oxide, lithium iron phosphate and lithium cobalt manganese; nickel metal hydride (NiMH); and sodium sulfur (NaS). Permanent damage to these types of energy-storage technologies occurs beyond the either extreme of their temperature ratings (either too hot or too cold); and this damage occurs more quickly or more slowly depending on such conditions as stat-of-charge and mode of operation such as charging or discharging.

Significant performance, cost and efficiency benefits can be obtained by operating and maintaining the battery system of a DES/CES within a temperature specification range. However, thermal management remains a design constraint. Solutions generally include addition of active heating and cooling elements in the DES/CES design. These elements add both initial installation and ongoing maintenance costs and potentially reduce reliability.

### BRIEF DESCRIPTION OF THE DRAWINGS

FIG. 1 is a diagram of a distributed energy storage unit incorporating thermal management in accordance with an embodiment of the invention.

### DETAILED DESCRIPTION

A passive cooling structure and method in accordance with the embodiments of the invention provides significant cost and performance advantages for DES/CES systems. Passive thermal management is obtained by uniquely adapting the DES/CES structure to advantageously use geothermal temperature stability to maintain the operating temperature of the DES/CES system.

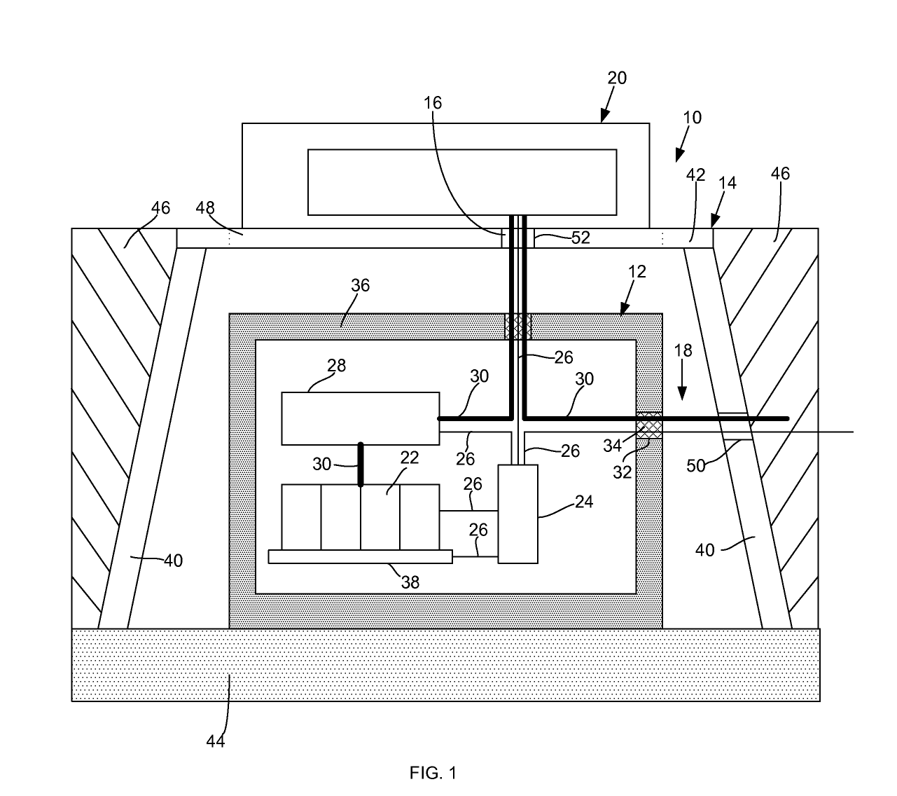

A CES 10 incorporates a geothermal temperature regulation system in accordance with an embodiment of the invention depicted in FIG. 1 and includes several features including:

1. A sealed, chemically inert storage energy container or “pack” 12;

2. An underground chamber and support structure or box pad 14; and

3. Mechanical and electrical interfaces (16, 18) both to the utility connections and to the CES converter unit 20.

The pack 12 includes a plurality of individual battery units 24 suitably electrically and mechanically coupled. While four battery units 22 are depicted (one identified in the drawing for clarity sake) it is understood that depending on the type of battery and the operating requirements of the CES there may be more or fewer. Also contained in the pack 12 are monitoring and control electronics 24 coupled by communication links 26 to the CES converter unit 20 and the utility. The pack 12 also includes power supply and inverter electronics 28 also coupled to the electronics 24 and also including power conductors 30 coupling to the batteries 22, the CES converter unit 20 and the utility. Coupling of links 26 and conductors 30 are via apertures 32 formed in the pack that include suitable liquid-tight seals 34. The pack 12 itself is oil-filled (not depicted) and hermetically sealed, depicted by the sealed wall structure 36, so that it is completely submersible. The use of individual batteries 22 within the pack 12 helps distribute heat evenly, reducing thermal gradients with the pack, and while not shown in FIG. 1 the batteries 22 themselves may be uniformly distributed within the pack 12. The thermal mass of the sealed pack is large, reducing battery-temperature swings even in the presence of widely varying ambient temperatures. The pack oil and battery electrolyte may be chosen to be environmentally benign to reduce concerns in the event of leakage and ground contamination. Auxiliary heaters 38 may also be provided, coupled to the batteries 22 and operating responsive to the electronics 24.

The pack 12 is disposed within the box pad 14. The box pad 14 may be prefabricated and include a four, sloped wall structure, frusto-conical or similar structure or box 40 and a top or pad 42. The box pad 14 may not include a bottom and as depicted in FIG. 1, the box pad 14 does not have a bottom. Instead, a hole is excavated and back filled with sand, gravel or other suitable substrate 44, which is leveled. The pack 12 sits upon the substrate 44. The required depth of the dug hole to achieve the desired mean temperature of the underground pack 12 environment can be accurately calculated through established equations that take into account such factors as daily variation in surface temperature, annual variation in surface temperature, solar radiation, water content of the soil, and mineral/clay content of the soil. In most applications, a hole depth determined by the actual dimensions of the box 40 will be sufficient to maintain the pack 12 within a desired temperature operating range. In such an arrangement, the pad 42 is even or slightly above the surrounding soil gradient.

The box pad 14 is lowered into the hole resting on the substrate 44. The balance of the hole is back-filled with the original soil 46 so that the pad 42 is at the desired grade. The box 40, being below grade ma fill with water, which may enhance geothermal temperature regulation. The box 40 may be dimensioned to accommodate packs 12 of various sizes and include apertures for wiring and connections in various configurations adding flexibility.

The mechanical and electrical interfaces 16 may include connections 18 to the utility and to the CES converter unit 20 including:

1. The box 40 is formed with apertures or side openings 50 to allow entry of buried cables;

2. The box 40 may be formed with structural features, such as ribs, bosses, wall portions and the like (not depicted) to guide and support the pack 12 during installation and removal, as well as to prevent toppling of the pack caused by ground heaves and settling during the years of use;

3. The pad 42 may be formed with a lid 48 that can be opened to allow access to the pack 12;

4. The pad 42 may contain apertures (one depicted but several may be provided) to allow interconnection of the pack 12 with the CES converter unit 20;

5. The pad 42 may include features to secure a service termination panel (not depicted) to CES converter unit 20 and/or to the pad 42;

6. The pad 42 may include features to secure the CES converter unit 20 to a service termination panel (not depicted) and the pack 12;

7. The pack 12 may include lifting hardware to facilitate installation and removal;

8. When installed the pack 12 stands in its tallest dimension to place interconnection cables with convenient reach for attachment and removal.

The geothermal cooling system adds reliability over devices that include active cooling, such as fans and pumps that require maintenance and have a limited service life. Moreover, thermally sensitive components are maintained and operated at a reliability-enhancing, stable temperature environment.

No energy is “stolen” from the electrical system to provide active cooling under most ambient conditions adding efficiency. The auxiliary heater 44 may be provided for contingency purposes either as an add-on device or integrated with the pack 12.

Installation and use are simple and consistent with customary utility installation of similar gear, such as pad-mounted transformers.

The system may be used with a wide variety of CES systems including 25-75 kWHr-class units. Moreover, virtually any thermally sensitive, heat generating component of the system may configured to be disposed within the box pad 14, with or without supplemental active heating or cooling.

While the present disclosure is susceptible to various modifications and alternative forms, certain embodiments are shown by way of example in the drawings and the herein described embodiments. It will be understood, however, that this disclosure is not intended to limit the invention to the particular forms described, but to the contrary, the invention is intended to cover all modifications, alternatives, and equivalents defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning Unless a claim element is defined by reciting the word “means” and a function without the recital of any structure, it is not intended that the scope of any claim element be interpreted based on the application of 35 U.S.C. §112, sixth paragraph.

We claim:

1. A geothermal temperature regulation system for a distributed energy system unit comprising:
an energy storage device;
an underground chamber defined by support structure, the energy storage device disposed within the chamber; and
mechanical and electrical interfaces to couple the energy storage device to a utility.

2. The system of claim 1, the unit comprising an inverter and the electrical interfaces couples the energy storage device to the inverter.

3. The system of claim 1, the support structure comprising a pad, the pad being at or above grade.

4. The system of claim 1, the energy storage device comprising batteries.

5. The system of claim 1, the energy storage device comprising batteries and electronics within a sealed container.

6. A method of managing temperature of an energy storage device for a distributed energy system unit; the method comprising:
providing an excavation to a predetermined depth;
disposing the energy storage device within the excavation; and
environmentally securing the energy storage device within the excavation.

7. The method of claim 6, wherein providing an excavation comprises providing an underground chamber defined by support structure, and disposing the energy storage device within the excavation comprises disposing the energy storage device within the chamber.

8. The method of claim 6, further comprising providing mechanical and electrical interfaces to couple the energy storage device to a utility.

9. The method of claim 8, wherein the energy storage device comprises an inverter and providing electrical interfaces comprises providing an electrical interface to the inverter.

10. The method of claim 6, further comprising providing a support structure for the excavation.

11. The method of claim 10, wherein providing the support structure comprises providing a pad disposed at or above grade.

12. The method of claim 6, the energy storage device comprising batteries and electronics, and the method comprises environmentally sealing the batteries and electronics within the excavation.
